(19) United States
(12) Patent Application Publication
(10) Pub. No.: US 2009/0128771 A1
(43) Pub. Date: May 21, 2009

(54) FABRICATION METHODS FOR LIQUID CRYSTAL DISPLAY DEVICES

(75) Inventors: Jen-Chieh Yang, Changhua County (TW); Yuan-Chang Liao, Yunlin County (TW); Jyh-Wen Shiu, Hsinchu County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/338,845

(22) Filed: Dec. 18, 2008

(30) Foreign Application Priority Data
Aug. 16, 2007 (TW) TW96130311

(51) Int. Cl. G02F 1/1341; B32B 38/00; B32B 38/14; B32B 38/04; B32B 38/10

(52) U.S. Cl. 349/189; 156/60; 156/273.3; 156/275.5; 156/269

(57) ABSTRACT

Fabrication methods for cholesteric liquid crystal display devices are presented. A roll of a first substrate is conveyed from a first direction. A patterned enclosure structure is formed on the roll of the first substrate, wherein the patterned enclosure structure includes a plurality of stripes for dividing liquid crystals. A roll of a second substrate is conveyed from a second direction. An adhesion layer is formed on the roll of the second substrate. The first and the second substrates are assembled by dual rollers, thereby tightly combining the adhesion layer and the patterned enclosure structure.

### BACKGROUND OF THE INVENTION

1. Field of the Invention

The invention relates to liquid crystal display (LCD) devices, and in particular to single layer color cholesteric liquid crystal display devices and fabrication methods thereof.

2. Description of the Related Art

Liquid crystal display (LCD) devices have many advantages over conventional cathode ray tube (CRT) devices, such as having a smaller size, lighter weight and lower power consumption. Additionally, LCD devices are applicable in a variety of electronic and communication devices including notebook computers, personal digital assistants (PDA), mobile phones and the like due to its lighter weight, thinner profile, and portability. Meanwhile, conventional reflective memorable color liquid crystal display devices are widely applicable in electronic books, electronic papers, and the likes. The structures and fabrication methods of conventional cholesteric liquid crystal display devices use a tri-layered red (R), green (G), and blue (B) pixel stacked structure which corresponds to various different driving methods. However, stacking tri-layered R, G, and B pixels may result in optical aberration and misalignment during fabrication. Moreover, the tri-layered R, G, and B liquid crystal layer stacked structure are so complicated that layout of electrodes is difficult to design and an LCD panel using the stacked structure has a rigid port, which require an intricate fabrication process, thus raising fabrication costs.

On the other hand, roll-to-roll fabrication techniques for flexible display devices have features of faster productivity, lower costs, and lighter and thinner volumes. Therefore, roll-to-roll fabrication techniques for flexible display devices are applicable to fabricating electronic books, electronic paper and other display regimes. Conventional color liquid crystal display devices are fabricated by using multiple lithography patterning processes. The multiple lithography patterning processes is beneficial for fabricating complex patterns and structures, but the tedious fabrication process can result in high production costs.

Conventionally, roll-to-roll fabrication techniques for flexible display devices focus not only on a single fabrication procedure but also on integration of the fabrication processes for the entire roll of flexible panel. U.S. Pat. No. 4,973,373, the entirety of which is hereby incorporated by reference, discloses a roll-to-roll fabrication method for a flexible display. By introducing a complex roller system to control tension, deformation and shift of the flexible substrate integrating patterned processes, fabrication of flexible displays are achieved. As to a passive matrix single-layered color display with memory effect, it is unnecessary to use such a complex roller system to fabricate the flexible display device.

U.S. Pat. No. 5,943,113, the entirety of which is hereby incorporated by reference, discloses roll-to-roll fabrication processes integrating a liquid crystal layer application, adhesive layer application, sealing frame application and assembly of upper and lower substrates. It is difficult, however, to perfectly integrate the liquid crystal layer application with the patterning process. Moreover, the display structure is different from the passive matrix single-layered color display with memory effect.

U.S. Pat. No. 7,018,180, the entirety of which is hereby incorporated by reference, discloses a fabrication method for a passive matrix drive liquid crystal display device. The fabrication method integrates application of transparent electrode patterns, a liquid crystal layer application and cutting processes. Such fabrication processes are not suitable for state-of-the-art panel applications due to its over-simplified processes for panel structures.

FIG. 1 is a schematic view of a conventional roll-to-roll fabrication method for a passive matrix drive liquid crystal display device. Referring to FIG. 1, the roll-to-roll fabrication method for a passive matrix drive liquid crystal display device includes conveying a roll of a lower substrate 60 to a patterned electrode application apparatus. The lower substrate 60 is then transited by a roller 50 to an adhesion layer application apparatus 80. An adhesion layer 81 is formed on the lower substrate 61. Meanwhile, a roll of an upper substrate 70 with a patterned electrode is provided, to be assembled with the lower substrate 60, by the substrate rolling apparatus 51. The assembled substrates are then conveyed to a curing apparatus 90. After curing in the curing apparatus 90, the assembled substrates are then cut by a cutting apparatus, a panel structure unit 21 is completed. A liquid crystal filling process and other following fabrication processes are then proceeded with the panel structure unit 21.

### BRIEF SUMMARY OF THE INVENTION

Embodiments of the invention provide a roll-to-roll fabrication method for a flexible liquid crystal display device. A thin-film application process is integrated with patterning roll-to-roll fabrication techniques. Partition structures, an adhesion layer, assembling the upper and the lower substrate, and curing the assembled structure are sequentially performed on the roll-to-roll substrates. After liquid crystal filling procedures, a flexible display device is completed.

Embodiments of the invention further provide a fabrication method for a liquid crystal display device, comprising: providing a roll of a first substrate from a first direction; forming a patterned structure on the first substrate, wherein the patterned structure includes a plurality of stripes for dividing liquid crystals; providing a roll of a second substrate from a second direction; forming an adhesion layer on the roll of the second substrate; and assembling the first and the second substrates by dual rollers, thereby tightly combining the adhesion layer and the patterned enclosure structure.

Embodiments of the invention also provide a fabrication method for a liquid crystal display device, comprising: providing a roll of a first substrate from a first direction; forming a patterned structure on the first substrate, wherein the patterned structure includes a plurality of stripes for dividing liquid crystals; providing a roll of a second substrate from a second direction; and assembling the first and the second substrates by dual rollers, thereby tightly combining the adhesion layer and the patterned enclosure structure.

### BRIEF DESCRIPTION OF THE DRAWINGS

The invention can be more fully understood by reading the subsequent detailed description and examples with references made to the accompanying drawings, wherein:

FIG. 1 is a schematic view of a conventional roll-to-roll fabrication method for a passive matrix drive liquid crystal display device;

FIG. 2 is a schematic view of an embodiment of a roll-to-roll fabrication method for a cholesteric liquid crystal display (LCD) device;

FIG. 3 is a flowchart illustrating an exemplary embodiment of a roll-to-roll fabrication method for a cholesteric LCD device;

FIGS. 4A-4C are schematic views of an exemplary embodiment of each assembly step of the first and second substrate structures of the invention;

FIG. 5 is a plan view of an embodiment of the enclosed structure of the invention;

FIG. 6 is a cross section of an embodiment of the substrate structure assembly taken along A-A line of FIG. 5; and

FIGS. 7A-7C are schematic views of an embodiment of each step of injecting each color LC into respective LC channels of the cholesteric LCD device of the invention.

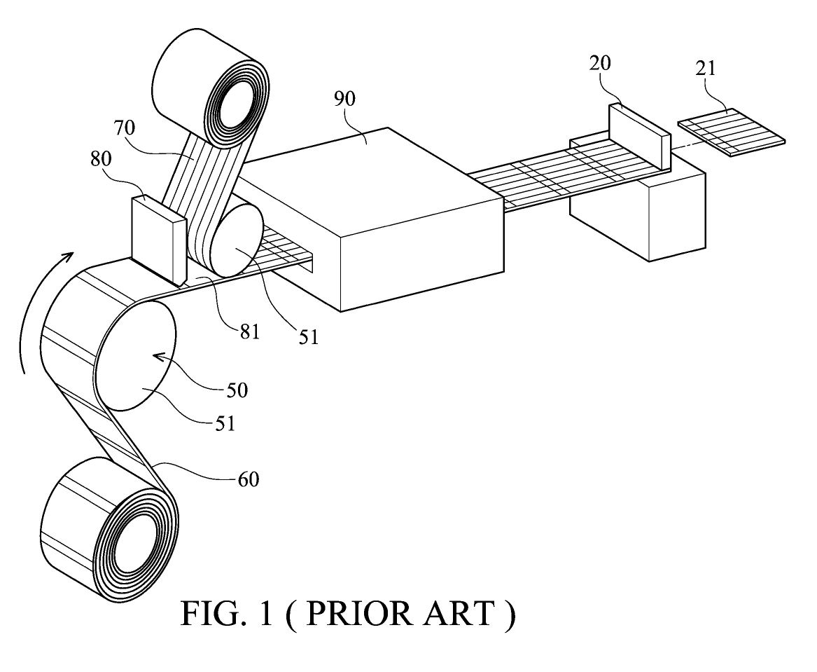

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

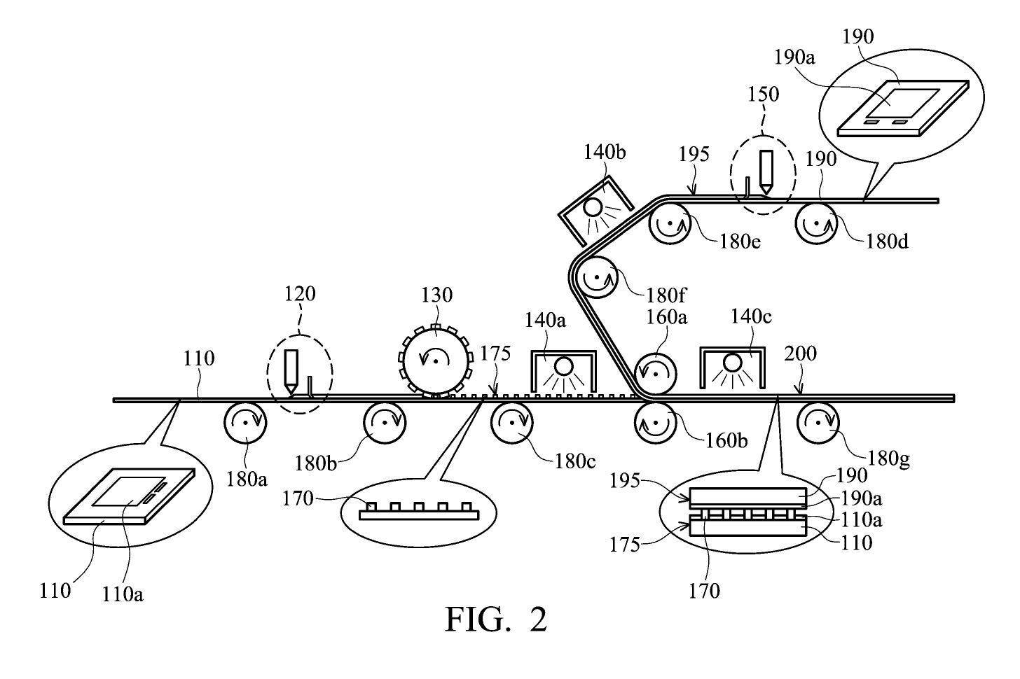

FIG. 2 is a schematic view of an embodiment of a roll-to-roll fabrication method for a cholesteric liquid crystal display device. Referring to FIG. 2, a roll of a first substrate 110 is conveyed from a first direction. The first substrate is made of a polycarbonate (PC) substrate, a polyethersulfone (PES) substrate, a polyethylene terephthalate (PET) substrate, a polyimide (PI) substrate, a p-nitrophenylbutyrate (PNB) substrate, a polyetheretherketone (PEEK) substrate, a polyethylenenapthalate (PEN), a polyetherimide (PEI) substrate, or a polyarylate (PAR) substrate. The roll of the first substrate 110 comprises a first patterned electrode 110a thereon. After passing through substrate transit rollers 180a and 180b, the first substrate 110 is sequentially conveyed to a partition structure application apparatus 120 and a partition patterning application apparatus 130 to form a patterned enclosure structure on the roll of the first substrate 110, wherein the patterned enclosure structure includes a plurality of stripes for dividing liquid crystals. Subsequently, the substrate 175 with the patterned structure thereon is conveyed through a substrate transit roller 180c to a curing apparatus 140a.

Note that the patterned structure comprises a photoset material, a thermoset material, or a photoresist. Formation of the patterned structure comprises inkjet printing, stripe coating, planar coating, roller pressing, screen printing, or thermal pressing. Furthermore, formation of the patterned structure comprises UV curing or thermal curing.

Meanwhile, a roll of a second substrate 190 is conveyed from a second direction. The second substrate 190 is made of a polycarbonate (PC) substrate, a polyethersulfone (PES) substrate, a polyethylene terephthalate (PET) substrate, a polyimide (PI) substrate, a p-nitrophenylbutyrate (PNB) substrate, a polyetheretherketone (PEEK) substrate, a polyethylenenapthalate (PEN), a polyetherimide (PEI) substrate, or a polyarylate (PAR) substrate. The roll of the second substrate 190 comprises a second patterned electrode 190a thereon. After passing through a substrate transit roller 180d, the second substrate 190 is sequentially conveyed to an adhesion layer application apparatus 150 to form an adhesion layer 195 on the roll of the second substrate. Subsequently, the second substrate 190 with the adhesion layer 195 thereon is conveyed through a substrate transit roller 180e to a curing apparatus 140b.

Note that the adhesion layer is made of a light solidified material or a thermoset material. Alternatively, the adhesion layer is made of a glue material and a solidified material. Moreover, formation of the adhesion layer comprises inkjet printing, stripe coating, planar coating, roller pressing, screen printing, or thermal pressing. Alternatively, formation of the adhesion layer comprises UV curing or thermal curing.

After passing through a substrate transit roller 180f, the roll of the second substrate 190 is assembled with the roll of a first substrate 110. Specifically, the first and the second substrates are assembled by dual rollers 160a and 160b, thereby tightly combining the adhesion layer and the patterned enclosure structure. Note that the step of assembling the first and the second substrates comprises roller pressing or thermal roller pressing. Alternatively, the step of assembling the first and the second substrates comprises adjusting roller pressure, speed, or temperature of the roller presser.

Subsequently, after assembled by the dual rollers 160a and 160b, the substrate assembly is transited to a curing apparatus 140c. A UV curing or thermal curing process is performed on the assembled first and second substrates. After passing through a substrate transit roller 180g, other following processing procedures are performed on the substrate assembly. For example, the roll of substrate assembly 200 is cut into desirable scales of a display panel, wherein the cutting step comprises dicing, laser cutting, blade cutting, or punch cutting.

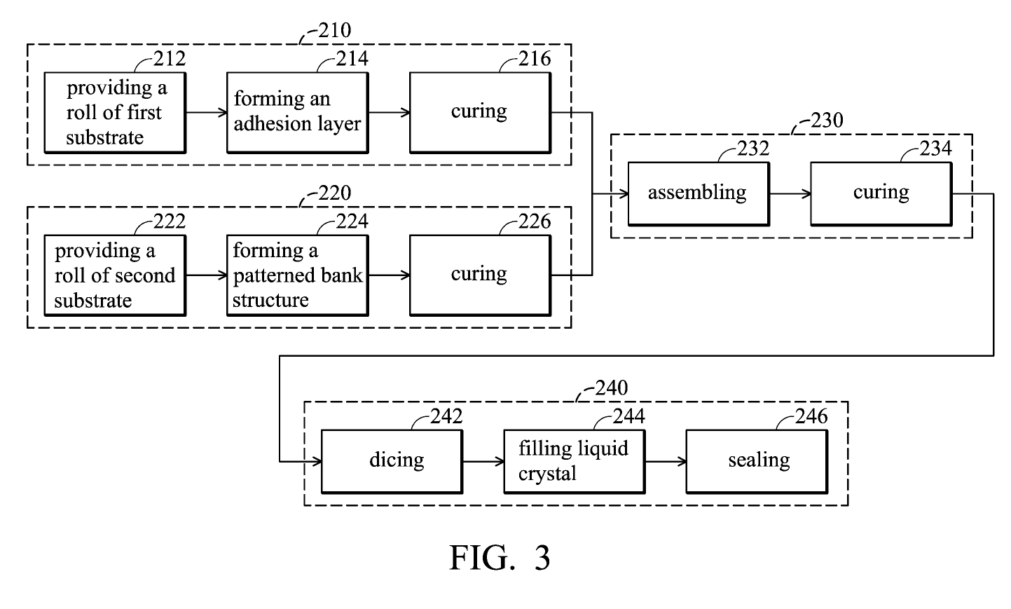

FIG. 3 is a flowchart illustrating an exemplary embodiment of a roll-to-roll fabrication method for a cholesteric LCD device. Referring to FIG. 3, in step 210, a roll of a first substrate with a patterned electrode thereon is provided (step 212). An adhesion layer is applied on the first substrate (step 214). After rolled into desirable patterns, the adhesion layer is cured (step 216). Meanwhile, in step 220, a roll of a second substrate with a patterned electrode thereon is provided (step 222). A structural layer is applied and rolled into a patterned enclosure structure (step 224). The patterned enclosure structure is then cured (step 226). Subsequently, in step 230, the first and second substrates are assembled, thereby creating an assembled unfilled liquid crystal substrate (step 232). The assembled unfilled liquid crystal substrate is then cured (step 234) to tightly combine the adhesion layer and the patterned enclosure structure, thereby preventing liquid crystal overflow during the liquid crystal filling process. In step 240, the roll of the substrate assembly 200 is cut into desirable scales of display panels (step 244). Following, liquid crystals are the filled in vacuum (step 244) and sealed (step 246).

Note that if the patterned enclosure structure is adhesive, application of the adhesive layer can be omitted. Since a reflective and single color liquid crystal display structure with memory effect is fabricated by some embodiments of the continuous roll-to-roll fabrication method, productivity can be improved and processing complexity can be lessened.

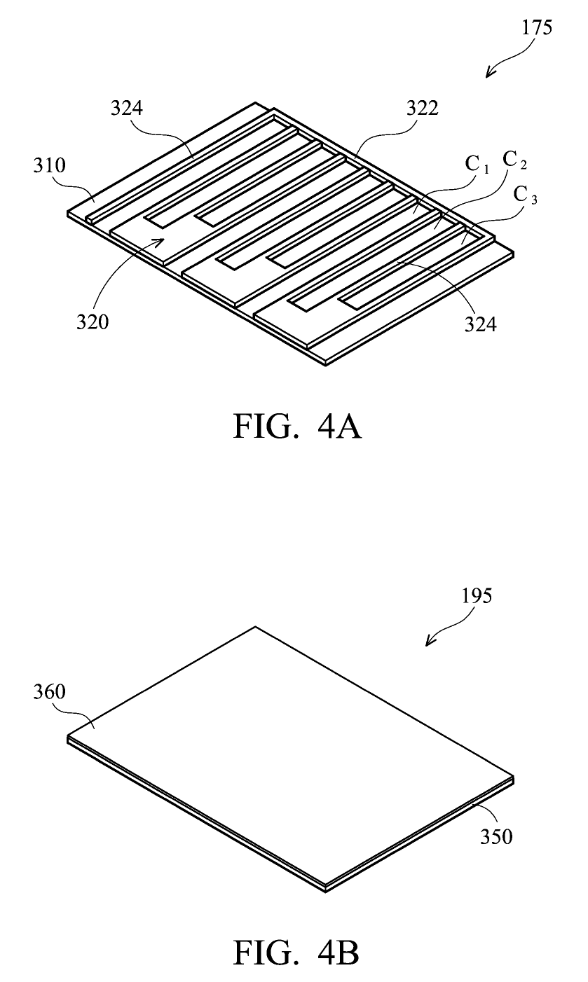

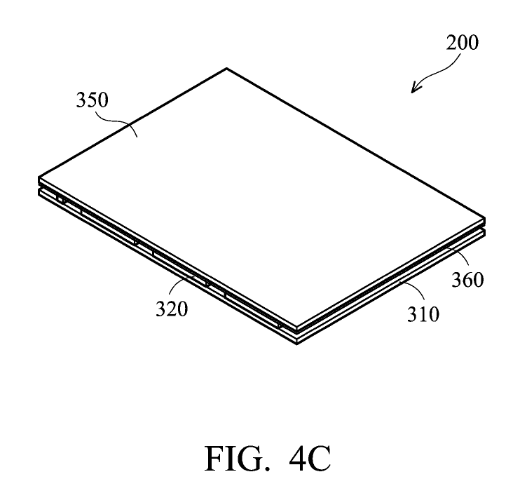

FIGS. 4A-4C are schematic views of an exemplary embodiment of each assembly step of the first and second substrate structures of the invention. Referring to FIG. 4A, a patterned enclosed structure 320 or a bank structure is formed on the roll of the first substrate 310. The structure of the first substrate 310 is substantially identical to the structure 175 in FIG. 2. The patterned enclosed structure 320 comprises a plurality of stripe wall structures 324. One end of each stripe wall structure 324 connects to and is perpendicular to a straight end line 322 to divide a first LC channel C₁ with a first LC injection opening, a second closed LC channel C₂, and a third closed LC channel C₃. The length of the first LC channel C₁ exceeds that of the second LC channel C₂, and the length of the second LC channel C₂ exceeds that of the third LC channel C₃.

The first substrate may further comprise circuit elements for controlling pixel electrodes such as a thin film transistor (TFT) and a capacitor. Alternatively and optionally, the first substrate comprises pixel electrodes such as linear first electrodes along a first direction and a first alignment layer overlying the first substrate.

Referring to FIG. 4B, an adhesion layer 360 is formed on the roll of the second substrate 350. The structure of the second substrate 350 is substantially identical to the structure 195 in FIG. 2. The second substrate 350 can comprises common electrodes, such as linear second electrodes along a second direction and a second alignment layer overlying the second substrate. The first direction and the second direction are substantially perpendicular to each other. The thickness of the adhesion layer 350 is less than the thickness (height) of the patterned enclosed structure 320.

Referring to FIG. 4C, the first substrate 310 and second substrate 320 are assembled opposing each other such that the patterned enclosed structure 320 and the adhesion layer 360 are tightly combined to prevent LC overflow between adjacent LC channels during injection of color LCs.

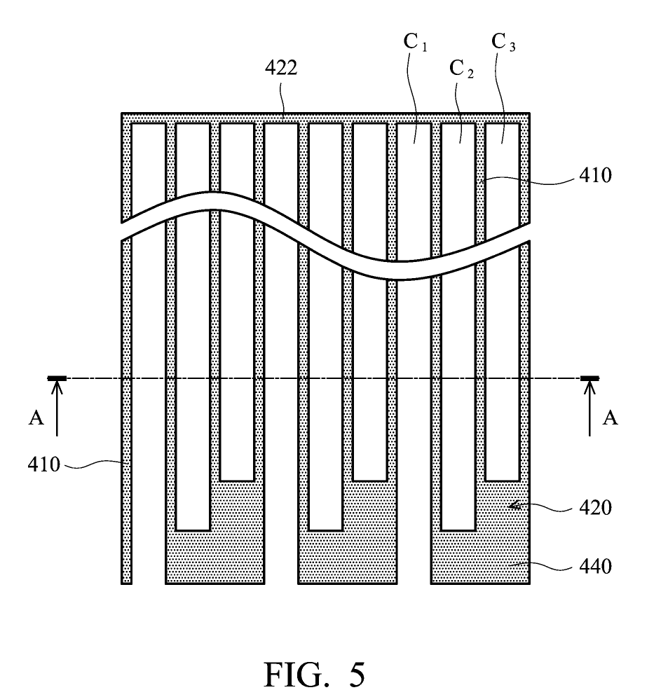

FIG. 5 is a plan view of an embodiment of the enclosed structure of the invention. In FIG. 5, a patterned enclosed structure 420 comprises a plurality of stripe wall structures 410. One end of each stripe wall structure 410 connects to and is perpendicular to a straight end line 422 and the other end of the stripe wall structures 410 connects to a bulk region 440, thereby dividing a first LC channel C₁ with a first LC injection opening, a second closed LC channel C₂, and a third closed LC channel C₃. The length of the first LC channel C₁ exceeds that of the second LC channel C₂, and the length of the second LC channel C₂ exceeds that of the third LC channel C₃. The bulk region 440 can enhance adhesion between the patterned enclosed structure and the adhesive layer, thereby preventing LC overflow between adjacent LC channels during injection of color LCs.

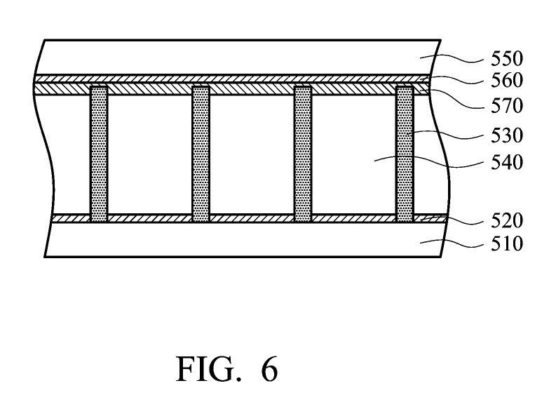

FIG. 6 is a cross section of an embodiment of the substrate structure assembly taken along A-A line of FIG. 5. Referring to FIG. 6, the combination of the first and second substrate structure includes the first substrate 510 and second substrate 550 opposed to each other with a plurality of parallel LC channels 540 for containing respective color LCs interposed therebetween. A linear electrode 520 such as a pixel electrode along the first direction is disposed on the first substrate 510. A linear electrode 560 such as a common electrode along the second direction is disposed on the second substrate 550. The patterned enclosed structure 530 and the adhesion layer 570 between the first substrate 510 and second substrate 550 are tightly combined to prevent LC overflow between adjacent LC channels during injection of color LCs. Note that if the patterned enclosure structure is adhesive, application of the adhesive layer can be omitted.

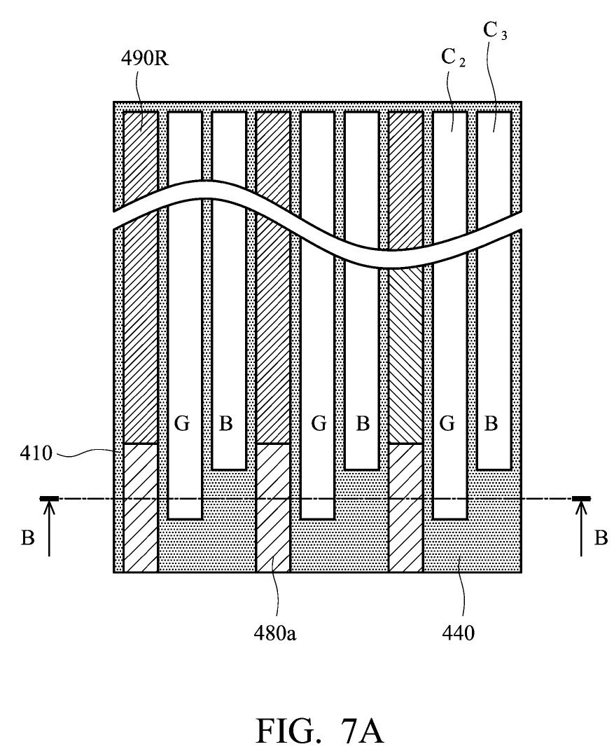

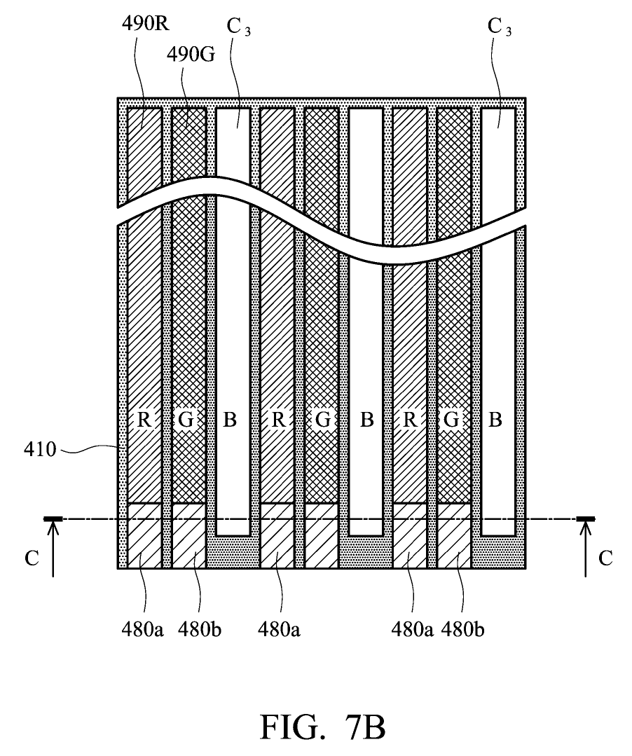

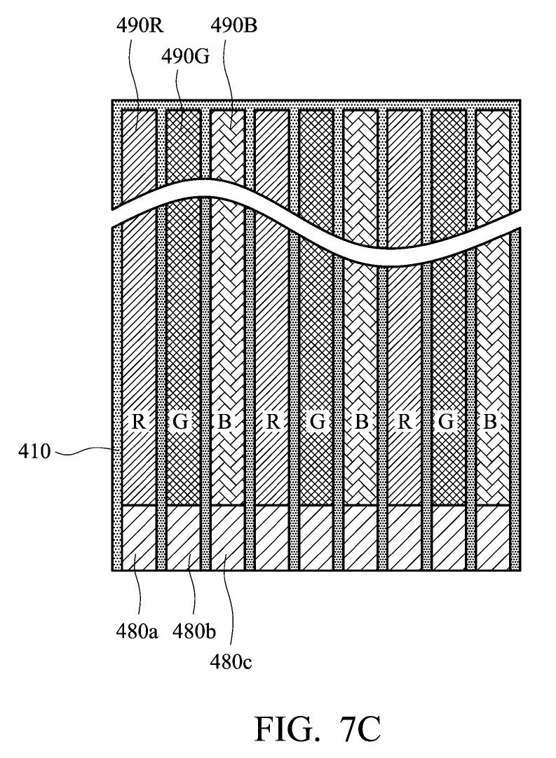

FIGS. 7A-7C are schematic views of an embodiment of each step of injecting each color LC into respective LC channels of the cholesteric LCD device of the invention. Referring to FIG. 7A, a first color (e.g., red) cholestic LC 490R is ejected into a first LC channel, and the first LC channel is then sealed by a first sealant 480a. For example, a red cholesteric CL material comprises mixture of red dye and twisted nematic liquid crystal layer doped with a chiral agent. The first sealant 480a can comprise a light solidified material or a thermoset material. Next, a first cutting procedure is performed such as along cutting line B-B to uncover the second stripe LC channel C₂. The first cutting procedure can be performed by dice-cutting and laser-cutting.

Referring to FIG. 7B, a second color (e.g., green) cholestic LC 490G is ejected into a second LC channel, and the second LC channel is then sealed by a second sealant 480b. For example, a green cholesteric CL material comprises mixture of green dye and twisted nematic liquid crystal layer doped with a chiral agent. The second sealant 480b can comprise a light solidified material or a thermoset material. Next, a second cutting procedure is performed such as along cutting line C-C to uncover the third stripe LC channel C₃. The second cutting procedure can be performed by dice-cutting and laser-cutting.

Referring to FIG. 7C, a third color (e.g., blue) cholestic LC 490B is ejected into a third LC channel, and the third LC channel is then sealed by a third sealant 480c. For example, a blue cholesteric CL material comprises mixture of blue dye and twisted nematic liquid crystal layer doped with a chiral agent. The third sealant 480c can comprise a light solidified material or a thermoset material. After all three color cholesteric LCs are filled and sealed, fabrication of the single layer color cholesteric LCD device is completed.

Note that in the abovementioned description in some embodiments, each color cholesteric LC layer of the invention can further comprise a polymer dispersed liquid crystal (PDLC) material. An LC fluid containing monomer or oligomer units would be injected into the stripe LC channels. After illuminated by UV light, the LC fluid containing monomer or oligomer units is polymerized into polymer dispersed liquid crystal (PDLC). By using a PDLC, sealing procedures of each stripe LC channel can be omitted. For example, after the first and second substrate structures are assembled, a first color liquid crystal is injected into the first LC channel. After the first color liquid crystal is polymerized, the assembly is cut to uncover a second opening of the second LC channel. Next, a second color liquid crystal is injected into the second LC channel. After the second color liquid crystal is polymerized, the assembly is cut to uncover a third opening of the third LC channel. A third color liquid crystal is injected into the third closed LC channel. The third color liquid crystal is then polymerized. After all the three color cholesteric LC are filled and sealed, fabrication of the single layer color cholesteric LCD device is completed.

Embodiments of the invention are advantageous in that the adhesive layer and the patterned enclosure structure are separately formed by roller pressing processes. The upper substrate and the lower substrate are assembled by dual rollers and then cured. The assembled structure is sequentially cut, injected red, green, and blue LC, and sealed to prevent color mixing and reduced color saturation. A single color liquid crystal display structure with memory effect is thus fabricated by simplified roll-to-roll fabrication methods, thereby improving productivity and reducing processing complexity.

While the invention has been described by way of example and in terms of the several embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such

What is claimed is:

1. A fabrication method for a liquid crystal display device, comprising:
providing a roll of a first substrate from a first direction;
forming a patterned structure on the first substrate, wherein the patterned structure includes a plurality of stripes for dividing liquid crystals;
providing a roll of a second substrate from a second direction;
forming an adhesion layer on the roll of the second substrate; and
assembling the first and the second substrates by dual rollers, thereby tightly combining the adhesion layer and the patterned enclosure structure.

2. The fabrication method as claimed in claim 1, further comprising filling a liquid crystal material between the first substrate and the second substrate, wherein the liquid crystal material comprises a cholesteric liquid crystal or a polymer dispersed liquid crystal (PDLC).

3. The fabrication method as claimed in claim 1, wherein the first substrate and the second substrate are made of flexible substrates.

4. The fabrication method as claimed in claim 1, wherein the first substrate and the second substrate are made of a polycarbonate (PC) substrate, a polyethersulfone (PES) substrate, a polyethylene terephthalate (PET) substrate, a polyimide (PI) substrate, a p-nitrophenylbutyrate (PNB) substrate, a polyetheretherketone (PEEK) substrate, a polyethylenenapthalate (PEN), a polyetherimide (PEI) substrate, or a polyarylate (PAR) substrate.

5. The fabrication method as claimed in claim 1, wherein the first substrate comprises a first patterned electrode thereon, and wherein the second substrate comprises a second patterned electrode thereon.

6. The fabrication method as claimed in claim 5, wherein the first patterned electrode and the second patterned electrode are stripe shaped and substantially perpendicular to each other.

7. The fabrication method as claimed in claim 1, wherein the patterned structure comprises a photoset material, a thermoset material, or a photoresist.

8. The fabrication method as claimed in claim 1, wherein formation of the patterned structure comprises inkjet printing, stripe coating, planar coating, roller pressing, screen printing, or thermal pressing.

9. The fabrication method as claimed in claim 1, wherein formation of the patterned structure comprises UV curing or thermal curing.

10. The fabrication method as claimed in claim 1, wherein the adhesion layer is made of a light solidified material or a thermoset material.

11. The fabrication method as claimed in claim 1, wherein the adhesion layer is made of a glue material and a solidified material.

12. The fabrication method as claimed in claim 1, wherein formation of the adhesion layer comprises inkjet printing, stripe coating, planar coating, roller pressing, screen printing, or thermal pressing.

13. The fabrication method as claimed in claim 1, wherein formation of the adhesion layer comprises UV curing or thermal curing.

14. The fabrication method as claimed in claim 1, wherein the step of assembling the first and the second substrates comprises roller pressing or thermal roller pressing.

15. The fabrication method as claimed in claim 14, wherein the step of assembling the first and the second substrates comprises adjusting roller pressure, speed, or temperature of the roller pressing.

16. The fabrication method as claimed in claim 1, wherein after assembling the first and the second substrates, the fabrications method further comprises performing UV curing or thermal curing on the assembled first and second substrates.

17. The fabrication method as claimed in claim 1, further comprising cutting the assembled first and second substrates, wherein the cutting step comprises dicing, laser cutting, blade cutting, or punch cutting.

18. A fabrication method for a liquid crystal display device, comprising:
providing a roll of a first substrate from a first direction;
forming a patterned structure on the first substrate, wherein the patterned structure includes a plurality of stripes for dividing liquid crystals;
providing a roll of a second substrate from a second direction; and
assembling the first and the second substrates by dual rollers, thereby tightly combining the adhesion layer and the patterned enclosure structure.

19. The fabrication method as claimed in claim 18, further comprising filling a liquid crystal material between the first substrate and the second substrate, wherein the liquid crystal material comprises a cholesteric liquid crystal or a polymer dispersed liquid crystal (PDLC).

20. The fabrication method as claimed in claim 18, wherein the first substrate and the second substrate are made of flexible substrates.

21. The fabrication method as claimed in claim 18, wherein the first substrate and the second substrate are made of a polycarbonate (PC) substrate, a polyethersulfone (PES) substrate, a polyethylene terephthalate (PET) substrate, a polyimide (PI) substrate, a p-nitrophenylbutyrate (PNB) substrate, a polyetheretherketone (PEEK) substrate, a polyethylenenapthalate (PEN), a polyetherimide (PEI) substrate, or a polyarylate (PAR) substrate.

22. The fabrication method as claimed in claim 18, wherein the first substrate comprises a first patterned electrode thereon, and wherein the second substrate comprises a second patterned electrode thereon.

23. The fabrication method as claimed in claim 22, wherein the first patterned electrode and the second patterned electrode are stripe shaped and substantially perpendicular to each other.

24. The fabrication method as claimed in claim 18, wherein the patterned structure comprises a material with adhesive characteristics.

25. The fabrication method as claimed in claim 18, wherein formation of the patterned structure comprises inkjet printing, stripe coating, planar coating, roller pressing, screen printing, or thermal pressing.

26. The fabrication method as claimed in claim 18, wherein formation of the patterned structure comprises UV pre-curing or thermal pre-curing.

27. The fabrication method as claimed in claim 18, wherein the step of assembling the first and the second substrates comprises roller pressing or thermal roller pressing.

28. The fabrication method as claimed in claim 27, wherein the step of assembling the first and the second substrates comprises adjusting roller pressure, speed, or temperature of the roller pressing.

29. The fabrication method as claimed in claim 18, wherein after assembling the first and the second substrates, the fabrication method further comprises performing UV curing or thermal curing on the assembled first and second substrates.

30. The fabrication method as claimed in claim 18, further comprising cutting the assembled first and second substrates, wherein the cutting step comprises dicing, laser cutting, blade cutting, or punch cutting.
